(19) United States
(12) Patent Application Publication
(10) Pub. No.: US 2016/0209652 A1
(43) Pub. Date: Jul. 21, 2016

(54) HALF MIRROR FOR DISPLAYING PROJECTED IMAGE AND PROJECTED IMAGE DISPLAY SYSTEM

(71) Applicant: FUJIFILM Corporation, Tokyo (JP)

(72) Inventor: Mitsuyoshi ICHIHASHI, Ashigarakami-gun (JP)

(73) Assignee: FUJIFILM Corporation, Tokyo (JP)

(21) Appl. No.: 15/086,452

(22) Filed: Mar. 31, 2016

Related U.S. Application Data
(63) Continuation of application No. PCT/JP2014/076403, filed on Oct. 2, 2014.

(30) Foreign Application Priority Data
Oct. 3, 2013 (JP) 2013-207940

(51) Int. Cl. G02B 27/01; G02B 5/30

(52) U.S. Cl. CPC G02B 27/0101; G02B 5/3016; G02B 2027/0194; G02B 2027/0114; G02B 2027/011; G02B 2027/012

(57) ABSTRACT

Provided are a half mirror for displaying a projected image having visible light transmittance, in which the selective reflection layer includes at least one layer formed by immobilizing a cholesteric liquid crystalline phase (for example, three or more layers formed by immobilizing a cholesteric liquid crystalline phase which exhibit different center wavelengths of selective reflection), and a transparent medium on at least one surface side of the selective reflection layer, and the transparent medium includes an inclined surface having an angle of 1° to 30° with respect to the surface of the selective reflection layer on the transparent medium side, and a projected image display system including the half mirror for displaying a projected image and a projector. The half mirror for displaying a projected image of the present invention is useful as a combiner of a head up display or the like.

### CROSS-REFERENCE TO RELATED APPLICATIONS

This application is a continuation of PCT International Application No. PCT/JP2014/076403 filed on Oct. 2, 2014, which claims priority under 35 U.S.C. §119 (a) to Japanese Patent Application No. 2013-207940 filed on Oct. 3, 2013, the entire content of which is incorporated herein by reference.

### BACKGROUND OF THE INVENTION

1. Field of the Invention

The present invention relates to a half mirror for displaying a projected image. More specifically, the present invention relates to a half mirror for displaying a projected image which is able to be used as a combiner of a head up display or a head mount display, and a projected image display system including the half mirror for displaying a video.

2. Description of the Related Art

A half mirror for displaying a projected image which is able to simultaneously display a video projected by a projector and front scenery is able to be used as a combiner or the like of a head up display, a head mount display, and the like. From the related art, glass, holograms, and the like which are subjected to metal compound coating have been used as a half mirror for a head up display (for example, JP1997-258020A (JP-H09-258020A) and JP1999-52283A (JP-H11-52283A)).

### SUMMARY OF THE INVENTION

The half mirror for displaying a projected image has been constantly required to have higher light transmittance and higher projection light reflectivity. In an onboard head up display and the like, a half mirror which is able to provide a projected image having more excellent visibility along with a peripheral image has been required from the viewpoint of safety. In addition, in order to spread the head up display, the head mount display, and the like, a half mirror which is able to be manufactured at low cost is also required. Further, in the combiner of the related art, a problem such as blurring of double images derived from reflection on a glass plate which is subjected to metal compound coating or a video derived from optical properties of a hologram itself is essential, and the problem has been constantly required to be solved.

An object of the present invention is to provide a novel half mirror for displaying a projected image according to the requirement described above.

In order to attain the object described above, the present inventors have conducted intensive studies and have found that it is possible to prepare a half mirror at low cost by using a cholesteric liquid crystal which has been known as having circularly polarized light selective reflection properties from the related art and to obtain high light transmittance and high projection light reflectivity. Therefore, the present inventors have further conducted studies and have found a novel problem that in the half mirror using the cholesteric liquid crystal, brightness and darkness or color unevenness (polarization dependency of reflectivity) occurs in a case where projection light includes polarized light or is observed by polarized sunglasses. In order to solve the novel problem, the present inventors have further conducted studies and have completed the present invention.

That is, the present invention provides [1] to [14] described below.

[1] A half mirror for displaying a projected image having visible light transmittance, including a selective reflection layer, in which the selective reflection layer includes at least one layer formed by immobilizing a cholesteric liquid crystalline phase, and a transparent medium on at least one surface side of the selective reflection layer, and the transparent medium includes an inclined surface having an angle of 1° to 30° with respect to a surface of the selective reflection layer on the transparent medium side.

[2] The half mirror for displaying a projected image according to [1], in which the transparent medium is directly in contact with the selective reflection layer or directly adheres to the selective reflection layer.

[3] The half mirror for displaying a projected image according to [1] or [2], in which the transparent medium is a homogeneous medium.

[4] The half mirror for displaying a projected image according to [3], in which a difference between a refractive index of the transparent medium and an in-plane average refractive index of the selective reflection layer is less than or equal to 0.05.

[5] The half mirror for displaying a projected image according to any one of [1] to [4], in which a layer formed by immobilizing a cholesteric liquid crystalline phase is not included on any one surface side of the transparent medium.

[6] The half mirror for displaying a projected image according to any one of [1] to [5], in which the inclined surface is on an outermost surface.

[7] The half mirror for displaying a projected image according to any one of [1] to [6], in which the transparent medium is included on both side surfaces of the selective reflection layer, and a film thickness is even.

[8] The half mirror for displaying a projected image according to any one of [1] to [7], in which the selective reflection layer includes three or more layers formed by immobilizing a cholesteric liquid crystalline phase, and the three or more layers formed by immobilizing the cholesteric liquid crystalline phase exhibit different selective reflection wavelengths.

[9] The half mirror for displaying a projected image according to [8], in which the three or more layers formed by immobilizing the cholesteric liquid crystalline phase are obtained by repeatedly forming another layer formed by immobilizing a cholesteric liquid crystalline phase directly on a surface of a layer formed by immobilizing a cholesteric liquid crystalline phase which is prepared in advance, and other layers are not included between any layers of the three or more layers formed by immobilizing the cholesteric liquid crystalline phase.

[10] The half mirror for displaying a projected image according to any one of [1] to [9], in which the half mirror for displaying a projected image includes a layer formed by immobilizing a cholesteric liquid crystalline phase which has a center wavelength of apparent selective reflection with respect to red light, a layer formed by immobilizing a cholesteric liquid crystalline phase which has a center wavelength of apparent selective reflection with respect to green light, and a layer formed by immobilizing a cholesteric liquid crystalline phase which has a center wavelength of apparent selective reflection with respect to blue light.

[11] The half mirror for displaying a projected image according to any one of [1] to [10], in which the half mirror for displaying a projected image is used as a combiner of a head up display.

[12] A projected image display system including a projector, and the half mirror for displaying a projected image according to any one of [1] to [11], in which a light emission wavelength of a light source of the projector is in a selective reflection band of the layer formed by immobilizing the cholesteric liquid crystalline phase.

[13] The projected image display system according to [12], in which the projector, the transparent medium, and the selective reflection layer are arranged in this order.

[14] The projected image display system according to [12] or [13], in which the projected image display system is used as a head up display.

According to the present invention, a novel half mirror for displaying a projected image is provided. The half mirror for displaying a projected image of the present invention is useful as a combiner of a head up display or the like. The half mirror for displaying a projected image of the present invention is manufactured at low cost compared to a half mirror which is subjected to metal compound coating or a half mirror of a hologram, and has high light transmittance and high projection light reflectivity, and thus, a problem of double images also rarely occurs. In addition, a problem of brightness and darkness or color unevenness rarely occurs even in a case where projection light includes polarized light or is observed by polarized sunglasses.

### BRIEF DESCRIPTION OF THE DRAWINGS

FIGS. 1A to 1C are diagrams illustrating a configuration example (a schematic sectional view) of a half mirror for displaying a projected image of the present invention.

FIG. 2 is a diagram illustrating a relationship between a schematic sectional view of a half mirror of Example 1 and a projection light direction.

FIG. 3 is a diagram illustrating a relationship between a schematic sectional view of a half mirror of Comparative Example 1 and a projection light direction.

### DESCRIPTION OF THE PREFERRED EMBODIMENTS

Hereinafter, the present invention will be described in detail.

Furthermore, herein, “to” is used as indication including numerical values before and after “to” as the lower limit value and the upper limit value.

Herein, “selective” applied to circular polarization indicates that the light amount of one of a right circular polarization component and a left circular polarization component of light to be emitted is greater than that of the other circular polarization component. Specifically, “selective” indicates that the degree of circular polarization of light is preferably greater than or equal to 0.3, is more preferably greater than or equal to 0.6, and is even more preferably greater than or equal to 0.8. Substantially, it is preferable that the degree of circular polarization of light is 1.0. Here, the degree of circular polarization is a value denoted by |I_{R}−I_{L}|/(I_{R}+I_{L}) at the time of setting the intensity of the right circular polarization component of the light to I_{R} and the intensity of the left circular polarization component of the light to I_{L}. Herein, the degree of circular polarization is used in order to indicate a ratio of the circular polarization components of light.

Herein, “sense” applied to circular polarization indicates whether the circular polarization is right circular polarization or left circular polarization. In the sense of the circular polarization, a case where a distal end of an electric field vector is rotated in a clockwise direction according to an increase in time in a case of watching the distal end such that light progresses towards the front is defined as the right circular polarization, and a case where the distal end is rotated in a counterclockwise direction is defined as the left circular polarization.

Herein, the term of “sense” may be used as a spiral twisted direction of a cholesteric liquid crystal. In selective reflection of a cholesteric liquid crystal, in a case where the spiral twisted direction (sense) of the cholesteric liquid crystal is right, right circularly polarized light is reflected and left circularly polarized light is transmitted, and in a case where the sense is left, left circularly polarized light is reflected and right circularly polarized light is transmitted.

Herein, “light” indicates visible light (natural light), unless otherwise particularly stated. A visible light ray is light having a wavelength visually observed among electromagnetic waves, and in general, is light in a wavelength range of 380 nm to 780 nm.

Herein, measurement of light intensity which is necessary in association with the calculation of light transmittance, for example, may be performed by a general visible spectrometer using air as a reference.

Herein, at the time of being simply referred to as “reflection light” or “transmission light”, the reflection light or the transmission light is used as an indication including scattering light and diffraction light.

Furthermore, a polarization state of each wavelength of light is able to be measured by using a spectral emission luminance meter on which a circularly polarizing plate is mounted or a spectrometer. In this case, the intensity of light measured through a left circularly polarizing plate corresponds to I_{R}, and the intensity of light measured through a right circularly polarizing plate corresponds to I_{L}. In addition, a general light source such as an incandescent bulb, a mercury lamp, a fluorescent lamp, and an LED emits approximately natural light, and properties of producing polarized light of a measurement target or the like such as a filter mounted thereon, for example, are able to be measured by using a polarization retardation analysis device AxoScan or the like manufactured by Axometrics, Inc.

In addition, the measurement is able to be performed by attaching the measurement target to an illuminometer or an optical spectrometer. A right circular polarization amount is measured by attaching a right circular polarization transmission plate, and a left circular polarization amount is measured by attaching a left circular polarization transmission plate, and thus, a ratio is able to be measured.

(Optical Properties of Half Mirror for Displaying Projected Image)

Herein, a half mirror for displaying a projected image indicates an optical member which is able to visibly display an image projected from a projector or the like and to simultaneously observe information or scenery on an opposite surface side at the time of observing the half mirror for displaying a projected image from the same surface side on which the image is displayed. That is, the half mirror for displaying a projected image has a function as an optical path combiner which displays external light and video light in a superposition.

The half mirror for displaying a projected image may have a function as a half mirror with respect to at least the projected light, and for example, it is not necessary that the half mirror for displaying a projected image has a function as a half mirror with respect to light in the entire visible light range. In addition, the half mirror for displaying a projected image may have a function as the optical path combiner described above with respect to the entire incidence angle, may have the function described above with respect to light having at least a part of the incidence angle, and for example, may include only a range of a specific incidence angle of less than or equal to 5 degrees, less than or equal to 10 degrees, less than or equal to 15 degrees, less than or equal to 20 degrees, less than or equal to 30 degrees, less than or equal to 40 degrees, and the like at the time of setting a normal direction of the half mirror for displaying a projected image to 0 degrees.

The half mirror for displaying a projected image has visible light transmittance in order to enable the information or the scenery on the opposite surface side to be observed. Having visible light transmittance indicates that the half mirror for displaying a projected image has light transmittance which is greater than or equal to 80%, is preferably greater than or equal to 90%, is more preferably 100%, is greater than or equal to 40%, is preferably greater than or equal to 50%, is more preferably greater than or equal to 60%, and is even more preferably greater than or equal to 70%, with respect to a wavelength range of visible light.

Optical properties of the half mirror for displaying a projected image of the present invention with respect to ultraviolet light or infrared light other than the visible light range are not particularly limited, and may include transmission, reflection, or absorption. In order to prevent deterioration of the half mirror for displaying a projected image and in order to perform heat insulation, eye protection for a user of the half mirror for displaying a projected image, or the like, it is preferable to include an ultraviolet light reflection layer or an infrared light reflection layer.

(Configuration of Half Mirror for Displaying Projected Image)

The half mirror for displaying a projected image of the present invention includes a selective reflection layer which selectively reflects any one of right circularly polarized light and left circularly polarized light and transmits the other sense of circularly polarized light in any one wavelength of a visible light range, and a transparent medium.

The selective reflection layer includes at least one layer formed by immobilizing a cholesteric liquid crystalline phase. Herein, the layer formed by immobilizing the cholesteric liquid crystalline phase may be referred to as a cholesteric liquid crystal layer or a liquid crystal layer.

The selective reflection layer selectively reflects any one of right circularly polarized light and left circularly polarized light and transmits the other sense of circularly polarized light in a selective reflection wavelength band. That is, the sense of the circularly polarized light to be reflected is left in a case where the sense of the circularly polarized light to be transmitted is right, and the sense of the circularly polarized light to be reflected is right in a case where the sense of the circularly polarized light to be transmitted is left. In a wavelength exhibiting selective reflection of projection light, it is possible to form a projected image by reflecting any one sense of the circularly polarized light according to the function of the selective reflection layer.

The half mirror for displaying a projected image of the present invention may include the transparent medium on at least one surface side of the selective reflection layer. That is, the transparent medium may be on any one surface side of the selective reflection layer, or may be on both surface sides thereof. In addition, in the half mirror for displaying a projected image of the present invention, it is preferable that the selective reflection layer and the cholesteric liquid crystal layer are not disposed on any one surface side of the transparent medium.

Furthermore, herein, in a case where a film object such as a layer or a filter is referred to as a “surface”, the surface indicates any one of two surfaces indicating a film area, and in a case of not being particularly stated, the surface does not indicate a surface in a thickness direction. The “surface” may have an angle with respect to an incidence direction of light in the use of the half mirror for displaying a projected image. For example, the surface described above may intersect with the incidence direction of the light by an angle of 30° to 90°, or the like. The “surface” may be a flat surface or a curved surface.

It is preferable that the transparent medium is a layer-like medium. In addition, it is preferable that the transparent medium on one surface side of the selective reflection layer is a layer-like medium covering the area of the one side surface by greater than or equal to 50%, greater than or equal to 60%, greater than or equal to 70%, greater than or equal to 80%, greater than or equal to 90%, greater than or equal to 95%, greater than or equal to 96%, greater than or equal to 97%, greater than or equal to 98%, or greater than or equal to 99%, and preferably substantially 100%.

One surface of the half mirror for displaying a projected image of the present invention may be inclined or may not be inclined with respect to the other surface. A filter in which both surfaces of the half mirror for displaying a projected image are approximately parallel to each other is preferable since the film thickness is even, and thus, handleability is excellent. Furthermore, herein, “approximately parallel” indicates a relationship in which it is preferable that an angle between both surfaces of the half mirror for displaying a projected image is less than 1°, less than or equal to 0.5°, less than or equal to 0.4°, less than or equal to 0.3°, less than or equal to 0.2°, less than or equal to 0.1°, less than or equal to 0.05°, less than or equal to 0.01°, or 0°.

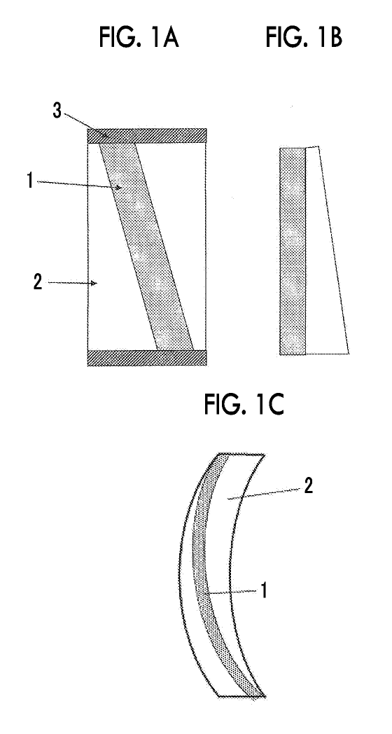

A configuration example of the half mirror for displaying a projected image of the present invention is illustrated in FIGS. 1A to 1C as a schematic sectional view (a configuration viewed from a surface in the thickness direction).

FIG. 1A is an example in which the transparent medium is included on both side surfaces of the selective reflection layer. Two transparent mediums having approximately the same shape are arranged on both side surfaces of the selective reflection layer such that two surfaces of the half mirror for displaying a projected image are approximately parallel to each other. A configuration where the transparent medium is on both side surfaces of the selective reflection layer is preferable compared to a configuration where the transparent medium illustrated in FIG. 1B is on only one side surface of the selective reflection layer, for example, since any one surface may be directed towards the projector, and thus, it is not necessary to adjust a direction.

As illustrated in FIG. 1A, the half mirror for displaying a projected image of the present invention may include a light absorption layer on the surface in the thickness direction. By including the light absorption layer on the surface of the thickness direction, it is possible to obtain circularly polarized light having a higher degree of circular polarization in which an influence of incidence light from the thickness direction or reflection light from the surface in the thickness direction in the filter is reduced.

FIG. 1B is an example in which the transparent medium is included on one side surface of the selective reflection layer, and has a structure in which one side surface of the half mirror for displaying a projected image is inclined with respect to the other surface. In a case of using the half mirror for displaying a projected image of the configuration of FIG. 1B in which the transparent medium is included on one side surface of the selective reflection layer, it is preferable that the transparent medium side is set to be on a projected image display side.

FIG. 1C is an example in which the transparent medium is on both side surfaces of the selective reflection layer, and is a configuration in which a configuration excluding the light absorption layer of the configuration of FIG. 1A is set to be in the shape of a concave surface.

Light incident from a normal direction of the selective reflection layer is refracted on an inclined surface which is a boundary between the transparent medium and air. In consideration of an optical path thereof, in order to further increase the degree of circular polarization, as necessary, the position of a light source or the position of an object to be irradiated with circularly polarized light may be adjusted.

The half mirror for displaying a projected image may be a thin film in the shape of a film, a sheet, a plate, or the like. The half mirror for displaying a projected image may be in the shape of a flat surface which does not include a curved surface, may include a curved surface, or may have a concave or convex shape as a whole and display the projected image in an enlarged or reduced size. In addition, the half mirror for displaying a projected image may adhere to other members and have the shapes described above, or may be in the shape of a roll or the like as a thin film before the adhesion.

(Layer Formed by Immobilizing Cholesteric Liquid Crystalline Phase: Cholesteric Liquid Crystal Layer)

Hereinafter, the cholesteric liquid crystal layer included in the selective reflection layer will be described.

The cholesteric liquid crystalline phase is known as exhibiting circular polarization selective reflection in which any one of right circularly polarized light and left circularly polarized light is selectively reflected and the other circularly polarized light is transmitted. In general, the cholesteric liquid crystalline phase selectively is able to reflect either right circularly polarized light or left circularly polarized light even in a case where the light is incident from any surface, and is able to selectively reflect any one sense of circularly polarized light by separating right circularly polarized light and left circularly polarized light even in a case where the light is incident from any surface, and is able to transmit the other sense of circularly polarized light to the other side surface side.

A film formed of a composition containing a polymerizable liquid crystal compound has been generally known as a film exhibiting circularly polarized light selective reflection properties from the related art, and the layer formed by immobilizing the cholesteric liquid crystalline phase (the cholesteric liquid crystal layer) can be referred to that in the related art.

The cholesteric liquid crystal layer may be a layer in which alignment of a liquid crystal compound formed of a cholesteric liquid crystalline phase is retained, and typically may be a layer in which the polymerizable liquid crystal compound is set to be in an alignment state of the cholesteric liquid crystalline phase and is subjected to ultraviolet ray irradiation, heating, or the like by polymerization and curing, and thus, a layer which does not have fluidity is formed and is simultaneously changed to a state where a change does not occurs in an alignment mode due to an external field or an external force. Furthermore, in the cholesteric liquid crystal layer, it is sufficient that optical properties of the cholesteric liquid crystalline phase are retained in the layer, and the liquid crystal compound of the layer may no longer exhibit liquid crystal properties. For example, the polymerizable liquid crystal compound may have a high molecular weight by a curing reaction, and may no longer have liquid crystal properties.

The cholesteric liquid crystal layer exhibits circular polarization reflection derived from a spiral structure of the cholesteric liquid crystal. Herein, the circular polarization reflection indicates selective reflection.

A center wavelength λ of the selective reflection depends on a pitch length P (=a cycle of a spiral) of the spiral structure in a cholesteric phase, and depends on a relationship of λ=n×P with an average refractive index n of the cholesteric liquid crystal layer. Furthermore, herein, the center wavelength λ of the selective reflection of the cholesteric liquid crystal layer indicates a wavelength in a gravity center position of a reflection peak of a circular polarization reflection spectrum measured from the normal direction of the cholesteric liquid crystal layer. As evident from the above description, it is possible to adjust the center wavelength of the selective reflection by adjusting the pitch length of the spiral structure. That is, for example, in order to selectively reflect any one of the right circularly polarized light and the left circularly polarized light with respect to blue light by adjusting an n value and a P value, the center wavelength λ is able to be adjusted, and the center wavelength of apparent selective reflection is able to be in a wavelength range of 450 nm to 495 nm. Furthermore, the center wavelength of the apparent selective reflection indicates a wavelength in a gravity center position of a reflection peak of a circular polarization reflection spectrum of the cholesteric liquid crystal layer measured from a practical observation direction (at the time of being used as the half mirror for displaying a projected image). For example, in a case where oblique light is incident on the cholesteric liquid crystal layer, the center wavelength of the selective reflection is shifted to a short wavelength side from the center wavelength at the time of performing measurement by allowing light to be incident from the normal direction of the cholesteric liquid crystal layer.

The pitch length of the cholesteric liquid crystalline phase depends on the type of chiral agent used along with the polymerizable liquid crystal compound or the addition concentration thereof, and thus, a desired pitch length is able to be obtained by adjusting the type of chiral agent or the addition concentration thereof. Furthermore, methods disclosed in “Introduction to Liquid Crystal Chemical Test”, Page 46, edited by Japan Liquid Crystal Society, published by Sigma Publications, 2007, and “Liquid Crystal Handbook”, Page 196, Liquid Crystal Handbook Editing Committee Maruzen are able to be used as a measurement method of the sense or the pitch of the spiral.

A cholesteric liquid crystal layer of which the sense of the spiral is either right or left is used as each of the cholesteric liquid crystal layers. The sense of the reflection circular polarization of the cholesteric liquid crystal layer is coincident with the sense of the spiral.

In a half value width Δλ (nm) of the selective reflection band exhibiting the circular polarization selective reflection, Δλ depends on birefringence Δn of the liquid crystal compound and the pitch length P, and depends on a relationship of Δλ=Δn×P. For this reason, the width of the selective reflection band is able to be controlled by adjusting Δn. An is able to be adjusted by adjusting the type of polymerizable liquid crystal compound or the mixing ratio thereof or by controlling a temperature at the time of immobilizing the alignment.

In order to form one type of cholesteric liquid crystal layer having the same center wavelength of the selective reflection, a plurality of cholesteric liquid crystal layers having the same cycle P and the same sense of the spiral may be laminated. By laminating the cholesteric liquid crystal layers having the same cycle P and the same sense of the spiral, it is possible to increase circular polarization selectivity in a specific wavelength.

The width of the selective reflection band, for example, is approximately 15 nm to 100 nm in a visible light range, in general, in one type of material. In order to increase the width of the selective reflection band, two or more cholesteric liquid crystal layers having different center wavelengths of the reflection light in which the cycle P is changed may be laminated. At this time, it is preferable that cholesteric liquid crystal layers having the same sense of the spiral are laminated. In addition, in one cholesteric liquid crystal layer, it is possible to increase the width of the selective reflection band by gradually changing the cycle P with respect to a film thickness direction. The width of the selective reflection band is not particularly limited, and may be a wavelength width of 1 nm, 10 nm, 50 nm, 100 nm, 150 nm, 200 nm, or the like. It is preferable that the width is approximately less than or equal to 100 nm.

It is preferable that the half mirror for displaying a projected image of the present invention has the center wavelength of the apparent selective reflection with respect to each of red light, green light, and blue light. This is because a full color projected image is able to be displayed. Specifically, it is preferable that the half mirror for displaying a projected image of the present invention is in a range of each of 750 nm to 620 nm, 630 nm to 500 nm, and 530 nm to 420 nm, and has three different center wavelengths of the selective reflection (for example, different by 50 nm or more). In consideration of a use mode in which oblique light is incident on the cholesteric liquid crystal layer, the half mirror for displaying a projected image of the present invention, it is preferable that the half mirror for displaying a projected image of the present invention has a center wavelength of selective reflection in a range of 490 nm to 570 nm, a center wavelength of selective reflection in a range of 580 nm to 680 nm, and a center wavelength of selective reflection in a range of 700 nm to 830 nm as a center wavelength at the time of performing measurement from the normal direction. Such properties are able to be attained by a configuration including three or more types of cholesteric liquid crystal layers as the selective reflection layer. Specifically, a configuration may include three or more types of cholesteric liquid crystal layers which have different cycles P, and thus, have different center wavelengths of the selective reflection. It is preferable that the half mirror for displaying a projected image of the present invention includes a cholesteric liquid crystal layer selectively reflecting either the right circularly polarized light or the left circularly polarized light with respect to red light (a cholesteric liquid crystal layer having a center wavelength of apparent selective reflection in 750 nm to 620 nm), a cholesteric liquid crystal layer selectively reflecting either the right circularly polarized light or the left circularly polarized light with respect to green light (a cholesteric liquid crystal layer having a center wavelength of apparent selective reflection in 630 nm to 500 nm), and a cholesteric liquid crystal layer selectively reflecting either the right circularly polarized light or the left circularly polarized light with respect to blue light (a cholesteric liquid crystal layer having a center wavelength of apparent selective reflection in 530 nm to 420 nm).

The center wavelength of the selective reflection of the cholesteric liquid crystal layer to be used is adjusted according to a light emission wavelength range of a light source to be used in projection and a use mode of the half mirror for displaying a projected image, and thus, a vivid projected image is able to be displayed with excellent light utilization efficiency. In particular, each center wavelength of selective reflection of a plurality of cholesteric liquid crystal layers is adjusted according to a light emission wavelength range or the like of a light source to be used in projection, and thus, a vivid color projected image is able to be displayed with excellent light utilization efficiency. In particular, examples of the use mode of the half mirror for displaying a projected image include an incidence angle of a projection light onto the half mirror for displaying a projected image surface, a projected image observation direction of the half mirror for displaying a projected image surface, and the like.

The senses of the spirals of the cholesteric liquid crystal layers having different center wavelengths of the selective reflection may be entirely identical to each other, or may be different from each other, but it is preferable that the senses of the spirals of the cholesteric liquid crystal layers are entirely identical to each other.

When the plurality of cholesteric liquid crystal layers are laminated, cholesteric liquid crystal layers separately prepared may be laminated by using an adhesive agent or the like, or a liquid crystal composition containing a polymerizable liquid crystal compound or the like may be directly applied onto the surface of a cholesteric liquid crystal layer which is formed in advance by the following method, and an alignment step and an immobilization step may be repeated, and the latter is preferable. This is because an alignment azimuth of liquid crystal molecules on an air boundary side of the cholesteric liquid crystal layer formed in advance is coincident with an alignment azimuth of liquid crystal molecules on a lower side of the cholesteric liquid crystal layer formed thereon, and polarization properties of a laminated body of the cholesteric liquid crystal layers become excellent by directly forming the next cholesteric liquid crystal layer on the surface of the cholesteric liquid crystal layer formed in advance. In addition, this is because in a case where an adhesive layer having a film thickness of generally 0.5 μm to 10 μm is used, interference unevenness derived from thickness unevenness of the adhesive layer is observed, and thus, it is preferable that the cholesteric liquid crystal layers are laminated without using the adhesive layer.

(Preparation Method of Layer Formed by Immobilizing Cholesteric Liquid Crystalline Phase)

Hereinafter, a preparation material and a preparation method of the cholesteric liquid crystal layer will be described.

Examples of the material used for forming the cholesteric liquid crystal layer include a liquid crystal composition containing a polymerizable liquid crystal compound and a chiral agent (an optical active compound), and the like. As necessary, the liquid crystal composition which is mixed with a surfactant, a polymerization initiator, or the like and is dissolved in a solvent or the like is applied onto a substrate (a support, an alignment film, a cholesteric liquid crystal layer which becomes a lower layer, and the like), a cholesteric alignment is matured, and then, is immobilized, and thus, the cholesteric liquid crystal layer is able to be formed.

Polymerizable Liquid Crystal Compound

The polymerizable liquid crystal compound may be a rod-like liquid crystal compound, or a disk-like liquid crystal compound, but it is preferable that the polymerizable liquid crystal compound is a rod-like liquid crystal compound.

Examples of a rod-like polymerizable liquid crystal compound forming the cholesteric liquid crystal layer include a rod-like nematic liquid crystal compound. Azomethines, azoxys, cyanobiphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, trans, and alkenyl cyclohexyl benzonitriles are preferably used as the rod-like nematic liquid crystal compound. Not only a low molecular liquid crystal compound but also a high molecular liquid crystal compound is able to be used.

The polymerizable liquid crystal compound is able to be obtained by introducing a polymerizable group into a liquid crystal compound. Examples of the polymerizable group include an unsaturated polymerizable group, an epoxy group, and an aziridinyl group, and an unsaturated polymerizable group is preferable, and an ethylenically unsaturated polymerizable group is particularly preferable. The polymerizable group is able to be introduced into the molecules of the liquid crystal compound by various methods. The number of polymerizable groups of the polymerizable liquid crystal compound is preferably 1 to 6, and is more preferably 1 to 3. Examples of the polymerizable liquid crystal compound include compounds disclosed in Makromol. Chem., Vol. 190, Page 2255 (1989), Advanced Materials Vol. 5, Page 107 (1993), the specifications of U.S. Pat. No. 4,683,327A, U.S. Pat. No. 5,622,648A, and U.S. Pat. No. 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), JP2001-328973A, and the like. Two or more types of polymerizable liquid crystal compounds may be combined. In a case where two or more types of polymerizable liquid crystal compounds are combined, it is possible to decrease an alignment temperature.

In addition, the added amount of the polymerizable liquid crystal compound to the liquid crystal composition is preferably 80 mass % to 99.9 mass %, is more preferably 85 mass % to 99.5 mass %, is particularly preferably 90 mass % to 99 mass %, with respect to the mass of solid contents of the liquid crystal composition (a mass excluding a solvent).

Chiral Agent (Optical Active Compound)

A chiral agent has a function of inducing a spiral structure of the cholesteric liquid crystalline phase. Senses or spiral pitches of a spiral induced are different according to a compound, and thus, a chiral compound may be selected according to the purpose.

The chiral agent is not particularly limited, a known compound (for example, disclosed in Liquid Crystal Device Handbook, Chapter 3, Paragraph 4-3, Chiral Agent for TN and STN, Page 199, Japan Society for the Promotion of Science edited by 142nd committee, 1989), and derivatives of isosorbide and isomannide are able to be used.

In general, the chiral agent includes an asymmetric carbon atom, but an axial asymmetric compound or a planar asymmetric compound which does not include an asymmetric carbon atom is also able to be used as the chiral agent. Examples of the axial asymmetric compound or the planar asymmetric compound include binaphthyl, helicene, paracyclophane, and derivatives thereof. The chiral agent may have a polymerizable group. In a case where both of the chiral agent and the liquid crystal compound have a polymerizable group, a polymer having a repeating unit derived from the polymerizable liquid crystal compound and a repeating unit derived from the chiral agent is able to be formed by a polymerization reaction between the polymerizable chiral agent and the polymerizable liquid crystal compound. In this embodiment, it is preferable that the polymerizable group of the polymerizable chiral agent is identical to the polymerizable group of the polymerizable liquid crystal compound. Accordingly, it is preferable that the polymerizable group of the chiral agent is also an unsaturated polymerizable group, an epoxy group, or an aziridinyl group, an unsaturated polymerizable group is more preferable, and an ethylenically unsaturated polymerizable group is particularly preferable.

In addition, the chiral agent may be a liquid crystal compound.

In a case where the chiral agent has a photoisomerizing group, it is preferable that a desired pattern of a reflection wavelength corresponding to a light emission wavelength is able to be formed by photomask irradiation of an active light ray or the like after coating and alignment. An isomerizing portion of a compound exhibiting photochromic properties, an azo group, an azoxy group, and a cinnamoyl group are preferable as the photoisomerizing group. Compounds disclosed in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A are able to be used as a specific compound.

The content of the chiral agent in the liquid crystal composition is preferably 0.01 mol % to 200 mol %, and is more preferably 1 mol % to 30 mol %, with respect to the amount of polymerizable liquid crystal compound.

Polymerization Initiator

It is preferable that the liquid crystal composition contains a polymerization initiator. In an embodiment where a polymerization reaction progresses by ultraviolet ray irradiation, it is preferable that a polymerization initiator to be used is a photopolymerization initiator which is able to initiate a polymerization reaction by ultraviolet ray irradiation. Examples of the photopolymerization initiator include an α-carbonyl compound (disclosed in each of the specifications of U.S. Pat. No. 2,367,661A and U.S. Pat. No. 2,367,670A), acyloin ether (disclosed in the specification of U.S. Pat. No. 2,448,828A), an α-hydrocarbon-substituted aromatic acyloin compound (disclosed in the specification of U.S. Pat. No. 2,722,512A), a polynuclear quinone compound (disclosed in each of the specifications of U.S. Pat. No. 3,046,127A and U.S. Pat. No. 2,951,758A), a combination of a triaryl imidazole dimer and p-aminophenyl ketone (disclosed in the specification of U.S. Pat. No. 3,549,367A), an acridine compound and phenazine compound (disclosed in JP-1985-105667A (JP-S60-105667A) and the specification of U.S. Pat. No. 4,239,850A), an oxadiazole compound (disclosed in the specification of U.S. Pat. No. 4,212,970A), and the like.

The content of the photopolymerization initiator in the liquid crystal composition is preferably 0.1 mass % to 20 mass %, and is more preferably 0.5 mass % to 5 mass %, with respect to the content of the polymerizable liquid crystal compound.

Cross-Linking Agent

The liquid crystal composition may arbitrarily contain a cross-linking agent in order to improve the film strength and durability after curing. A cross-linking agent which is cured by an ultraviolet ray, heat, humidity, and the like is able to be suitably used as the cross-linking agent.

The cross-linking agent is not particularly limited, but is able to be suitably selected according to the purpose, and examples of the cross-linking agent include a multifunctional acrylate compound such as trimethylol propane tri(meth)acrylate and pentaerythritol tri(meth)acrylate; an epoxy compound such as glycidyl (meth)acrylate and ethylene glycol diglycidyl ether; an aziridine compound such as 2,2-bishydroxy methyl butanol-tris[3-(1-aziridinyl) propionate] and 4,4-bis(ethylene iminocarbonyl amino) diphenyl methane; an isocyanate compound such as hexamethylene diisocyanate and biuret type isocyanate; a polyoxazoline compound having an oxazoline group in a side chain; an alkoxy silane compound such as vinyl trimethoxy silane and N-(2-aminoethyl)-3-aminopropyl trimethoxy silane, and the like. In addition, a known catalyst is able to be used according to reactivity of the cross-linking agent, and improvement of productivity is able to be attained in addition to improvement of film strength and durability improvement. One type of the cross-linking agent may be independently used, or two or more types thereof may be used in combination.

The content of the cross-linking agent is preferably 3 mass % to 20 mass %, and is more preferably 5 mass % to 15 mass %. In a case where the content of the cross-linking agent is less than 3 mass %, an effect of improving the density of the cross-linking is not obtained, and in a case where the content of the cross-linking agent is greater than 20 mass %, stability of the cholesteric liquid crystal layer may decrease.

Alignment Control Agent

An alignment control agent may be added to the liquid crystal composition in order to stably or rapidly contribute to the formation of a cholesteric liquid crystal layer having planar alignment. Examples of the alignment control agent include a fluorine (meth)acrylate-based polymer disclosed in paragraphs [0018] to [0043] and the like of JP2007-272185A, compounds denoted by Formulas (I) to (IV) disclosed in paragraphs [0031] to [0034] and the like of JP2012-203237A, and the like.

Furthermore, one type of the alignment control agent may be independently used, or two or more types thereof may be used in combination.

The added amount of the alignment control agent to the liquid crystal composition is preferably 0.01 mass % to 10 mass %, is more preferably 0.01 mass % to 5 mass %, and is particularly preferably 0.02 mass % to 1 mass %, with respect to the total mass of the polymerizable liquid crystal compound.

Other Additives

In addition to the additives described above, the liquid crystal composition may contain at least one selected from various additives such as a surfactant for making a film thickness even by adjusting a surface tension of a coated film, a polymerizable monomer, and the like. In addition, a polymerization inhibitor, an antioxidant, an ultraviolet absorbent, a light stabilizer, a coloring material, metal oxide fine particles, and the like are able to be further added to the liquid crystal composition, as necessary, in a range where optical performance does not decrease.

The cholesteric liquid crystal layer is able to form a cholesteric liquid crystal layer in which cholesteric regularity is immobilized by applying the liquid crystal composition in which the polymerizable liquid crystal compound and the polymerization initiator, and the chiral agent, the surfactant, and the like, added as necessary, are dissolved in a solvent onto the support, the alignment layer, the cholesteric liquid crystal layer prepared in advance, and the like, by drying the liquid crystal composition, by obtaining a coated film, by irradiating the coated film with an active light ray, and by polymerizing the cholesteric liquid crystal composition. Furthermore, a laminated film formed of a plurality of cholesteric liquid crystal layers is able to be formed by repeatedly performing a manufacturing step of the cholesteric liquid crystal layer.

The solvent used for preparing the liquid crystal composition is not particularly limited, but is able to be suitably selected according to the purpose, and an organic solvent is preferably used.

The organic solvent is not particularly limited, but is able to be suitably selected according to the purpose, and examples of the organic solvent include ketones, alkyl halides, amides, sulfoxides, a heterocyclic compound, hydrocarbons, esters, ethers, and the like. One type of the organic solvent may be independently used, or two or more types thereof may be used in combination. Among them, the ketones are particularly preferable in consideration of a load on the environment.

A coating method of the liquid crystal composition with respect to the substrate is not particularly limited, but is able to be suitably selected according to the purpose, and examples of the coating method include a wire bar coating method, a curtain coating method, an extruding coating method, a direct gravure coating method, a reverse gravure coating method, a die coating method, a spin coating method, a dip coating method, a spray coating method, a slide coating method, and the like. In addition, the coating method is able to be performed by transferring a liquid crystal composition applied onto a separate support onto the substrate. The coated liquid crystal composition is heated, and thus, liquid crystal molecules are aligned. A heating temperature is preferably lower than or equal to 200° C., and is more preferably lower than or equal to 130° C. By this alignment treatment, an optical thin film is able to be obtained in which the polymerizable liquid crystal compound is subjected to twisted alignment such that the polymerizable liquid crystal compound includes a spiral axis in a direction substantially perpendicular to a film surface.

The aligned liquid crystal compound may be further polymerized. The polymerization may be either thermal polymerization or photopolymerization of light irradiation, and the photopolymerization is preferable. It is preferable that the light irradiation is performed by using an ultraviolet ray. The irradiation energy is preferably 20 mJ/cm² to 50 J/cm², and is more preferably 100 mJ/cm² to 1,500 mJ/cm². In order to accelerate the photopolymerization reaction, the light irradiation may be performed under heating conditions or a nitrogen atmosphere. It is preferable that an irradiation wavelength of the ultraviolet ray is 350 nm to 430 nm. It is preferable that polymerization reactivity is high from the viewpoint of stability, and the polymerization reactivity is preferably greater than or equal to 70%, and is more preferably greater than or equal to 80%. The polymerization reactivity is able to determine a consumption ratio of a polymerizable functional group by using an IR absorption spectrum.

(Transparent Medium)

The transparent medium includes the inclined surface having an angle of 1° to 30° with respect to the surface of the selective reflection layer on the transparent medium side. The present inventors have coincidentally found that the degree of circular polarization of reflection light obtained from the selective reflection layer including the cholesteric liquid crystal layer remarkably increases by using the transparent medium including the inclined surface. In addition, the present inventors have found that brightness and darkness or color unevenness in the half mirror for displaying a projected image is reduced, and thus, a problem of double images also rarely occurs. Therefore, the present inventors have further conducted studies, and thus, have found that it is preferable that the inclination is 1° to 30° with respect to the surface of the selective reflection layer on the transparent medium side. Herein, having an angle of 1° to 30° may indicate that a portion having an angle of 1° to 30° between intersecting surfaces is included in the half mirror for displaying a projected image, or may indicate that an angle between intersecting extension surfaces is 1° to 30° when the extension surfaces which respectively simply include surfaces is assumed. The angle described above may be 1° to 30°, is preferably 2° to 15°, and is more preferably 3° to 7°.

Furthermore, herein, the angle described above, that is, an angle between the surface of the selective reflection layer on the transparent medium side and the inclined surface indicates an “inclination angle”. In addition, herein, a term of “inclination direction” may be used. The “inclination direction” indicates that the inclined surface is inclined to have an angle which is directed towards any direction in the plane of the selective reflection layer on the transparent medium side. The inclination direction of the inclined surface of the half mirror for displaying a projected image of the present invention is not particularly limited.

As illustrated in FIGS. 1A and 1B, in the inclination, the inclination direction and the inclination angle may be the same over the entire surface of the half mirror for displaying a projected image. In addition, in the inclination, the inclination direction may be continuous, that is, the inclination direction may be the same over the entire inclined surface, and the inclination angle may not be continuous, that is, may be changed. In addition, when the surface of the selective reflection layer on the transparent medium side is a curved surface, as illustrated in FIG. 1C, the inclined surface of the transparent medium may be inclined as the curved surface corresponding to the curved surface, and in a projection direction of light, the transparent medium may include a curved surface having a tangent which is continuously inclined with respect to a tangent of the curved surface of the selective reflection layer on the transparent medium side. For example, a transparent medium may be used in which the film thickness is changed in a fixed direction.

In the half mirror for displaying a projected image of the present invention, it is preferable that the inclined surface is on the outermost surface.

In the wavelength of a visible light range, light transmittance of the transparent medium may be greater than or equal to 50%, greater than or equal to 60%, greater than or equal to 70%, greater than or equal to 80%, greater than or equal to 90%, greater than or equal to 95%, greater than or equal to 99%, or substantially 100%. The light transmittance of the transparent medium may be high or low in a wavelength range other than the specific wavelength range described above.

In addition, it is preferable that the transparent medium has a difference in a refractive index of the average refractive index (the in-plane average refractive index) of the selective reflection layer in a control wavelength range. Specifically, the difference may be less than or equal to 0.2, less than or equal to 0.1, or less than or equal to 0.05. In general, the selective reflection layer including the cholesteric liquid crystal layer or the cholesteric liquid crystal layer has the average refractive index of approximately 1.55 to 1.6, and thus, the refractive index of the transparent medium, for example, may be in a range of 1.3 to 1.8, and may be preferably in a range of 1.4 to 1.7.

Catalog values of various optical films in a polymer handbook (JOHN WILEY&SONS, INC) are able to be used as the average refractive index. In a case where the value of the average refractive index is not known, the value of the average refractive index is able to be measured by an Abbe's refractometer. The value of the average refractive index of a main optical film is exemplified as follows: Cellulose Acylate (1.48), Cycloolefin Polymer (1.52), Polycarbonate (1.59), Polymethyl Methacrylate (1.49), and Polystyrene (1.59). In addition, the refractive index of glass is approximately 1.51.

Further, it is preferable that the transparent medium has low birefringence. Herein, the low birefringence indicates that front retardation is less than or equal to 10 nm in a control wavelength range. It is preferable that the front retardation described above is less than or equal to 5 nm. Furthermore, herein, the retardation is a value having a unit of nm which is measured by using AxoScan or the like manufactured by Axometrics, Inc. A value which is measured by allowing light having a wavelength in a visible light wavelength range, such as the center wavelength of the selective reflection of the reflection layer to be incident in a film normal direction using KOBRA 21ADH or WR (manufactured by Oji Scientific Instruments) is able to be used as the front retardation.

The transparent medium may be formed of one homogeneous medium, or may be formed of a plurality of mediums.

Examples of the transparent medium formed of one homogeneous medium include a glass plate, a plastic plate, and the like. Specifically, examples of the material of the transparent medium are able to include glass, a polymer such as polystyrene, a polymethyl methacrylate resin, a fluorine resin, polyethylene, polycarbonate, an acrylic resin, polyester, an epoxy resin, polyurethane, polyamide, polyolefin, a cellulose derivative, and silicone (including modified silicone such as silicone polyurea), and a material formed by performing polymerization and immobilization with respect to an acrylic monomer, epoxy, and an oxetane monomer.

Examples of the transparent medium formed of a plurality of mediums include a medium having a configuration in which a layer formed of a composition (a polymer composition or a polymerizable composition to be subjected to polymerization and immobilization) applied to have an inclination is disposed on a flat glass plate or a plastic film, a medium formed by introducing a composition having fluidity between two flat glass plates or two plastic films, a laminated body of a plurality of transparent films, and the like. For example, the materials described as an example of the transparent medium formed of one homogeneous medium described above are able to be used as the material of each medium in the transparent medium formed of a plurality of mediums.

In addition, the alignment layer, the adhesive layer, the support, and the like, described below, may configure all or a part of the transparent medium.

It is preferable that a substance having a large difference in a refractive index with respect to the average refractive index of the selective reflection layer is not included between the surface of the selective reflection layer on the transparent medium side and the inclined surface of the transparent medium. In other words, it is preferable that a substance which considerably changes an advancing direction of light reflected on the half mirror for displaying a projected image is not included between the surface of the selective reflection layer on the transparent medium side and the inclined surface of the transparent medium in a state where the substance considerably changes the advancing direction of the light. In particular, it is preferable that a layer having a large difference in a refractive index with respect to the average refractive index of the selective reflection layer is not included on an optical path of the half mirror for displaying a projected image. For example, it is preferable that a substance having a difference in a refractive index of greater than 0.2, a substance having a difference in a refractive index of greater than 0.1, and a substance having a difference in a refractive index of greater than 0.05 are not included. In addition, it is preferable that a gas medium such as air is not substantially included between the surface of the selective reflection layer on the transparent medium side and the inclined surface. This is because a gas phase has a large difference in a refractive index with respect to the average refractive index of the selective reflection layer. Further, it is preferable that only the transparent medium or only the adhesive layer for allowing the transparent medium and the selective reflection layer to adhere to the transparent medium exists between the surface of the selective reflection layer on the transparent medium side and the inclined surface of the transparent medium. That is, it is preferable that the transparent medium is directly in contact with the selective reflection layer, or directly adheres to the selective reflection layer.

As described above, the half mirror for displaying a projected image includes the transparent medium including the inclined surface, and thus, in a case where projection light includes polarized light or is observed by polarized sunglasses, brightness and darkness or color unevenness rarely occurs, and a problem of double images also rarely occurs. It is considered that the polarization dependency of the circular polarization selective reflectivity, the brightness and darkness, or the color unevenness is affected by reflection light of natural light on the surface of the half mirror or on the substrate, and it is possible to separate the reflection light and circular polarization selective reflection light from the selective reflection layer by including the transparent medium including the inclined surface. Accordingly, in the half mirror for displaying a projected image of the present invention, the antireflection layer may not be disposed.

In particular, by setting the entire thickness of the half mirror to be even as a configuration in which the transparent medium is disposed on both sides of the selective reflection layer, it is possible to prevent a position deviation of a peripheral image observed through the half mirror and to prevent a color variation in the peripheral image due to a prism effect.

(Other Layers)

In addition to the selective reflection layer and the transparent medium, the half mirror for displaying a projected image may include a layer such as an alignment layer, a support, an adhesive layer, and a substrate. It is preferable that all of the other layers are transparent and have low birefringence, as described with respect to the transparent medium, and have a small difference in a refractive index with respect to the average refractive index (the in-plane average refractive index) of the circular polarization separate layer. On the other hand, it is preferable that the half mirror for displaying a projected image does not include a light shielding layer which reflects or absorbs light. It is possible to obtain high transparency (light transmittance of greater than or equal to 60%, preferably greater than or equal to 70%) for viewing the surrounding scenery or information on a side opposite to the half mirror. In addition, it is preferable that the half mirror for displaying a projected image does not include a layer having front retardation of greater than or equal to 10 nm, and in particular, a layer having front retardation of greater than or equal to 20 nm. The half mirror for displaying a projected image of the present invention may or may not include a lens (a field lens or the like) for setting light to be a telecentric optical system in a reflection surface of light. Even in a case where the lens described above is not included, in the half mirror for displaying a projected image of the present invention, reflection light having a high degree of circular polarization is able to be obtained. In addition, even in a case where the lens described above is not included, in the half mirror for displaying a projected image of the present invention, brightness and darkness or color unevenness rarely occurs, and a problem of double images also rarely occurs.

(Support)

The support is not particularly limited. The support used for forming the cholesteric liquid crystal layer may be a temporary support which is peeled off after forming the cholesteric liquid crystal layer. In a case where the support is a temporary support, the support does not become a layer configuring the half mirror for displaying a projected image of the present invention, and thus, optical properties such as transparency or refraction properties are not particularly limited. In addition to a plastic film, glass and the like may be used as the support (the temporary support). Examples of the plastic film include polyester such as polyethylene terephthalate (PET), polycarbonate, an acrylic resin, an epoxy resin, polyurethane, polyamide, polyolefin, a cellulose derivative, silicone, and the like.

The film thickness of the support may be approximately 5 μm to 1000 μm, is preferably 10 μm to 250 μm, and is more preferably 15 μm to 90 μm.

(Alignment Film)

The alignment film is able to be disposed by means such as a rubbing treatment of an organic compound and a polymer (a resin such as polyimide, polyvinyl alcohol, polyester, polyarylate, polyamide imide, polyether imide, polyamide, and modified polyamide), oblique vapor deposition of an inorganic compound, the formation of a layer having a microgroove, or the accumulation of an organic compound (for example, an co-tricosanoic acid, dioctadecyl methyl ammonium chloride, and methyl stearate) using a Langmuir-Blodgett method (an LB film). Further, an alignment film is also known in which an alignment function occurs by application of an electric field, application of a magnetic field, or light irradiation.

In particular, it is preferable that an alignment film formed of a polymer is subjected to a rubbing treatment, and then, a composition is applied onto a rubbing treatment surface in order to form a liquid crystal layer. The rubbing treatment is able to be performed by rubbing the surface of the polymer layer with paper and cloth in a constant direction a plurality of times.

The liquid crystal composition may be applied onto the support surface or the surface of the support which is subjected to the rubbing treatment without disposing the alignment film.

In a case where the support is a temporary support, the alignment film may not become a layer configuring the half mirror for displaying a projected image of the present invention by being peeled off along with the temporary support.

The thickness of the alignment layer is preferably 0.01 μm to 5 μm, and is more preferably 0.05 μm to 2 μm.

(Adhesive Layer)

The adhesive layer may be formed of an adhesive agent.

Examples of the adhesive agent include a hot melt type adhesive agent, a thermal curing type adhesive agent, a photocuring type adhesive agent, a reaction curing type adhesive agent, and a pressure sensitive adhesion type adhesive agent in which curing is not necessary, from the viewpoint of a curing method, and a compound such as an acrylate-based compound, a urethane-based compound, a urethane acrylate-based compound, an epoxy-based compound, an epoxy acrylate-based compound, a polyolefin-based compound, a modified olefin-based compound, a polypropylene-based compound, an ethylene vinyl alcohol-based compound, a vinyl chloride-based compound, a chloroprene rubber-based compound, a cyanoacrylate-based compound, a polyamide-based compound, a polyimide-based compound, a polystyrene-based compound, and a polyvinyl butyral-based compound is able to be used as a material of each adhesive agent. From the viewpoint of workability and productivity, the photocuring type adhesive agent is preferable in a curing method, and from the viewpoint of optical transparency and heat resistance, the acrylate-based compound, the urethane acrylate-based compound, the epoxy acrylate-based compound, and the like are preferably used as the material.

The film thickness of the adhesive layer may be 0.5 μm to 10 μm, and may be preferably 1 μm to 5 μm. In order to reduce color unevenness or the like of the half mirror for displaying a projected image, it is preferable that the film thickness becomes even.

(Application)

The half mirror for displaying a projected image of the present invention is combined with various projectors, and thus, is able to be used for displaying a projected image. That is, the half mirror for displaying a projected image of the present invention is able to be used as a configuration member of a projected image display system. The projected image display system, for example, may be a projected image display device, may be an integration of the half mirror for displaying a projected image and the projector, or may be used as a combination of the half mirror for displaying a projected image and the projector.

Herein, the projected image does not indicate the surrounding scenery, but indicates a video based on light projection from the projector to be used. The projected image may be a video having a single color, or may be a video having a multicolor or a full color. The projected image may be formed by reflection light of a half mirror. The projected image may be displayed and viewed on the half mirror for displaying a projected image surface of the present invention, or may be a virtual image which is viewed as floating on the half mirror for displaying a projected image in a case of being viewed by an observer.

The projector which is combined with the half mirror for displaying a projected image of the present invention is not particularly limited insofar as the projector has a function of projecting an image. Examples of the projector include a liquid crystal projector, a digital light processing (DLP) projector using a digital micromirror device (DMD), a grating light valve (GLV) projector, a liquid crystal on silicon (LCOS) projector, a CRT projector, and the like. The DLP projector and the grating light valve (GLV) projector may use microelectromechanical systems (MEMS).

A laser light source, an LED, a discharge tube, and the like are able to be used as a light source of the projector.

Specific examples of the application of the half mirror for displaying a projected image of the present invention include a flat mirror, a concave mirror, a convex mirror, and the like for virtual image formation of various projectors, such as a reflection mirror used in a combiner of a head up display or a projection device, a reflection screen for a see-through display, a reflection mirror for a head mount display, and a dichroic mirror. The application as the combiner of the head up display can be referred to that in JP2013-79930A and WO2005/124431A.

In particular, the half mirror for displaying a projected image of the present invention is useful at the time of being used in combination with the projector using laser of which a light emission wavelength is not continuous in a visible light range, an LED, an OLED, and the like in a light source. The center wavelength of the selective reflection of the cholesteric liquid crystal layer is able to be adjusted according to each light emission wavelength. In addition, a liquid crystal display device (LCD), an OLED, and the like are able to be used for projection of a display of which display light is polarized.

### EXAMPLES

Hereinafter, the present invention will be described in more detail with reference to examples. Materials, reagents, substance quantities and ratios thereof, operations, and the like described in the following examples are able to be suitably changed insofar as the change is not departed from the gist of the present invention. Accordingly, the scope of the present invention is not limited to the following examples.

### Example 1

A coating liquid A-1 shown in Table 1 was applied onto a rubbing treatment surface of PET manufactured by Fujifilm Corporation which had been subjected to a rubbing treatment at room temperature by using a wire bar such that the thickness of a dried film after being dried became 3 μm. A coated layer was dried at room temperature for 30 seconds, and then, was heated in an atmosphere of 85° C. for 2 minutes, and after that, UV irradiation was performed at 70° C. with an output of 60% for 6 seconds to 12 seconds by a D valve (a lamp of 90 mW/cm) manufactured by Heraeus K. K., and thus, a liquid crystal layer was obtained. The coating liquid A-2 shown in Table 1 was applied onto the liquid crystal layer at room temperature such that the thickness of a dried film after being dried became 3.5 μm, and after that, drying, heating, and UV irradiation were performed by the same method as described above, and thus, a second liquid crystal layer was formed. Further, a coating liquid A-3 shown in Table 1 was applied onto the second liquid crystal layer at room temperature such that the thickness of a dried film after being dried became 4 μm, and after that, drying, heating, and UV irradiation were performed by the same method as described above, and thus, a third liquid crystal layer was formed, and a cholesteric liquid crystal layer 1 having center wavelengths of selective reflection at 450 nm, 530 nm, and 640 nm was obtained.

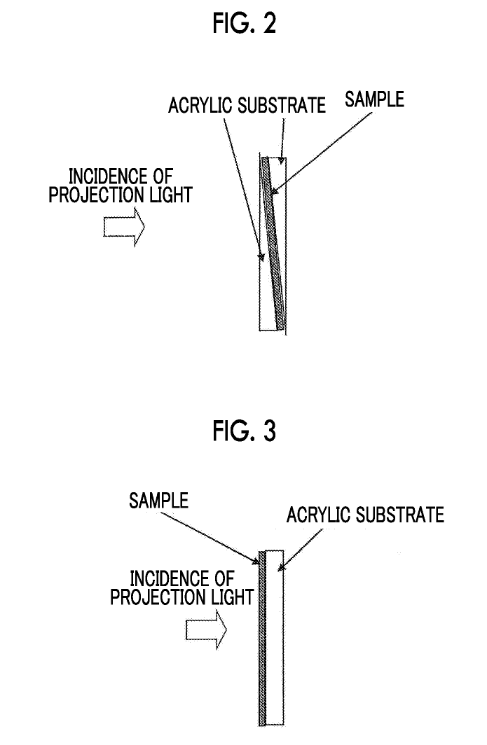

A transparent medium of an acrylic resin in the shape of a triangular prism having a vertical size of 7 cm, a horizontal size of 6 mm, and a height of 20 cm was prepared, and a UV curing type adhesive agent Exp. U12034-6 manufactured by DIC Corporation was applied onto the inclined surface thereof at room temperature by using a wire bar such that the thickness of a dried film after being dried became 5 μm. The coating surface thereof was bonded to the surface of the cholesteric liquid crystal layer 1 prepared as described above on a liquid crystal layer side such that air bubbles were not contained, and after that, UV irradiation was performed at 30° C. with an output of 60% for 6 seconds to 12 seconds by using a D valve (a lamp of 90 mW/cm) manufactured by Heraeus K. K., and then, PET of a base was peeled off. Further, the same adhesive agent was applied onto the liquid crystal layer, another transparent medium of an acrylic resin in the shape of a triangular prism having a vertical size of 7 cm, a horizontal size of 6 mm, and a height of 20 cm was bonded to the liquid crystal layer such that air bubbles were not contained, and the same curing was performed. A sectional view of the formed half mirror of Example 1 is illustrated in FIG. 2.

### Example 2

The coating liquid A-2 shown in Table 1 was applied onto a rubbing treatment surface of PET manufactured by Fujifilm Corporation which had been subjected to a rubbing treatment at room temperature by using a wire bar such that the thickness of a dried film after being dried became 3.5 μm. A coated layer was dried at room temperature for 30 seconds, and then, was heated in an atmosphere of 85° C. for 2 minutes, and after that, UV irradiation was performed at 70° C. with an output of 60% for 6 seconds to 12 seconds by a D valve (a lamp of 90 mW/cm) manufactured by Heraeus K. K., and thus, a cholesteric liquid crystal layer 2 having a reflection peak wavelength at 530 nm was obtained. The cholesteric liquid crystal layer 2 was disposed and bonded between a pair of transparent mediums of an acrylic resin in the shape of a triangular prism having a vertical size of 7 cm, a horizontal size of 6 mm, and a height of 20 cm by the same method as that in Example 1, and thus, a half mirror of Example 2 was formed.

### Comparative Example 1

A cholesteric liquid crystal layer 1 was formed by the same method as that in Example 1. The cholesteric liquid crystal layer 1 was bonded to a plate-like transparent substrate of an acrylic resin having a vertical size of 7 cm, a thickness of 6 mm, and a length of 20 cm by using the same adhesive agent and the same procedure as those in Example 1, and thus, a half minor of Comparative Example 1 having a sectional structure illustrated in FIG. 3 was formed.

### Comparative Example 2

A cholesteric liquid crystal layer 2 was formed by the same method as that in Example 2. The cholesteric liquid crystal layer 2 was bonded to a plate-like transparent substrate of an acrylic resin having a vertical size of 7 cm, a thickness of 6 mm, and a length of 20 cm by using the same adhesive agent and the same procedure as those in Example 1, and thus, a half mirror of Comparative Example 2 having the same structure as that of Comparative Example 1 was formed.

The evaluation results of the half mirrors prepared in the examples and the comparative examples are shown in Table 2. Furthermore, in Table 2, the left side of the layer configuration of the prepared half mirror is described as a projected image display side (a projection light incidence side), and in a case of including a rubbed surface, the left side of the position of the rubbed surface is also similarly described as the projected image display side in a relationship with respect to the layer configuration. In addition, “R reflection Ch” indicates a cholesteric liquid crystal layer having a center wavelength of selective reflection at 640 nm, “G reflection Ch” indicates a cholesteric liquid crystal layer having a center wavelength of selective reflection at 530 nm, and “B reflection Ch” indicates a cholesteric liquid crystal layer having a center wavelength of selective reflection at 450 nm.

In Table, natural light transmittance is measured by using a visible ultraviolet spectrophotometer, and indicates average transmittance with respect to natural light in a wavelength region of 380 nm to 780 nm Projection light reflectivity is measured by using a visible ultraviolet spectrophotometer, Example 2 and Comparative Example 2 indicate regular reflectivity with respect to natural light having a wavelength of 530 nm, and Example 1 and Comparative Example 1 indicate the average value of regular reflectivity with respect to natural light having wavelengths of 450 nm, 530 nm, and 640 nm.

The evaluation of reflection unevenness in-plane evenness was performed as follows. The half mirror (a sample) was horizontally disposed on a black underlay (black velvet) such that the projection light side surface thereof was on the upper side. As illustrated in FIGS. 1A to 1C, the sample was irradiated with light of white Schaukasten in which a linear polarizing plate was bonded to a light emission surface from the upper surface, and thus, in-plane evenness of reflection light of the sample was visually evaluated.
A: The unevenness is not able to be viewed.
B: The unevenness is observed but is difficult to be viewed.
C: The unevenness is observed.
D: The unevenness is remarkably observed.

The evaluation of the double images was performed by allowing green laser pointer light to be incident on the projection light side surface side of the half mirror, and by performing visual observation on the basis of the following criteria.
A: The double images are difficult to be viewed.
B: The double images are remarkably viewed.

The degree of circular polarization of the reflection light is calculated by disposing right and left circularly polarizing plates on a light receiving section side and by measuring each reflectivity of the circularly polarizing plates using a visible ultraviolet spectrophotometer, in Example 2 and Comparative Example 2, the degree of circular polarization of the reflection light indicates the degree of circular polarization of a wavelength of 530 nm, and in Example 1 and Comparative Example 1, the degree of circular polarization of the reflection light indicates the average value of the degrees of circular polarization of three wavelengths of 450 nm, 530 nm, and 640 nm.

TABLE 1

| | | Coating Liquid Name | | |
|---|---|---|---|---|
| Material (Type) | Material Name (Maker) | A-1 | A-2 | A-3 |
| Liquid Crystal Compound | Compound 1 | 100 | 100 | 100 |
| | | Parts by Mass | Parts by Mass | Parts by Mass |
| Polymerization Initiator | Irg-819 | 4 | 4 | 4 |
| | (Manufactured by BASF | Parts by Mass | Parts by Mass | Parts by Mass |
| | SE) | | | |
| Air Boundary Side Alignment | Compound 2 | 0.04 | 0.04 | 0.04 |
| Control Agent | | Parts by Mass | Parts by Mass | Parts by Mass |
| Chiral Agent | LC-756 | 6.7 | 5.6 | 4.7 |
| | (Manufactured by BASF | Parts by Mass | Parts by Mass | Parts by Mass |
| | SE) | | | |
| Solvent | 2-butanol | Suitably | Suitably | Suitably |
| | (Manufactured by Wako | Adjusted | Adjusted | Adjusted |
| | Pure Chemical Industries, | according to | according to | according to |
| | Ltd.) | Film Thickness | Film Thickness | Film Thickness |

[Chemical Formula 1]
Compound 1 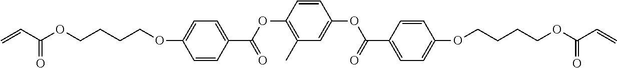 [SMILES: C=CC(=O)OCCCCOc1ccc(C(=O)Oc2ccc(OC(=O)c3ccc(OCCCCOC(=O)C=C)cc3)c(C)c2)cc1]
Compound 2

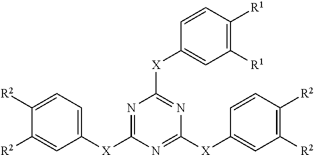

| R¹ | R² | X |
|---|---|---|
| O(CH₂)₂O(CH₂)₂(CF₂)₆F | O(CH₂)₂O(CH₂)₂(CF₂)₆F | NH |

TABLE 2

| | | | | | | Degree of |
|---|---|---|---|---|---|---|
| | | | | | | Circular |
| | | Natural | Projection | In-Plane | | Polarization of |
| | Configuration: Left Side is | Light | Light | Evenness | | Reflection |
| | Projection Light Incidence | Transmit- | Reflec- | of Un- | Double | Light (Average |
| | Side | tance/% | tivity/% | evenness | Images | Value) |
| Example 1 | Acrylic Wedge Substrate/R | 74 | 48 | A | A | 0.98 |
| | Reflection Ch/G Reflection | | | | | |
| | Ch/B Reflection Ch | | | | | |
| | (Rubbing Surface)/Acrylic | | | | | |
| | Wedge Substrate | | | | | |
| Example 2 | Acrylic Wedge Substrate/G | 86 | 47 | A | A | 0.99 |
| | Reflection Ch (Rubbing | | | | | |
| | Surface)/Acrylic Wedge | | | | | |
| | Substrate | | | | | |
| Comparative | R Reflection Ch/G | 74 | 53 | D | B | 0.86 |
| Example 1 | Reflection Ch/B Reflection | | | | | |
| | Ch (Rubbing Surface)/ | | | | | |
| | Acrylic Flat Substrate | | | | | |
| Comparative | G Reflection Ch (Rubbing | 86 | 52 | D | B | 0.87 |
| Example 2 | Surface)/Acrylic Flat | | | | | |
| | Substrate | | | | | |

### EXPLANATION OF REFERENCES

1: selective reflection layer
2: transparent medium
3: light absorption layer

What is claimed is:

1. A half mirror for displaying a projected image having visible light transmittance, comprising:
a selective reflection layer,
wherein the selective reflection layer includes at least one layer formed by immobilizing a cholesteric liquid crystalline phase, and a transparent medium on at least one surface side of the selective reflection layer, and
the transparent medium includes an inclined surface having an angle of 1° to 30° with respect to a surface of the selective reflection layer on the transparent medium side.

2. The half mirror for displaying a projected image according to claim 1,
wherein the transparent medium is directly in contact with the selective reflection layer or directly adheres to the selective reflection layer.

3. The half mirror for displaying a projected image according to claim 1,
wherein the transparent medium is a homogeneous medium.

4. The half mirror for displaying a projected image according to claim 3,
wherein a difference between a refractive index of the transparent medium and an in-plane average refractive index of the selective reflection layer is less than or equal to 0.05.

5. The half mirror for displaying a projected image according to claim 1,
wherein a layer formed by immobilizing a cholesteric liquid crystalline phase is not included on any one surface side of the transparent medium.

6. The half mirror for displaying a projected image according to claim 1,
wherein the inclined surface is on an outermost surface.

7. The half mirror for displaying a projected image according to claim 1,
wherein the transparent medium is included on both side surfaces of the selective reflection layer, and
a film thickness is even.

8. The half mirror for displaying a projected image according to claim 1,
wherein the selective reflection layer includes three or more layers formed by immobilizing a cholesteric liquid crystalline phase, and
the three or more layers formed by immobilizing the cholesteric liquid crystalline phase exhibit different selective reflection wavelengths.

9. The half mirror for displaying a projected image according to claim 8,
wherein the three or more layers formed by immobilizing the cholesteric liquid crystalline phase are obtained by repeatedly forming another layer formed by immobilizing a cholesteric liquid crystalline phase directly on a surface of a layer formed by immobilizing a cholesteric liquid crystalline phase which is prepared in advance, and
other layers are not included between any layers of the three or more layers formed by immobilizing the cholesteric liquid crystalline phase.

10. The half mirror for displaying a projected image according to claim 1, further comprising:
a layer formed by immobilizing a cholesteric liquid crystalline phase which has a center wavelength of apparent selective reflection with respect to red light;
a layer formed by immobilizing a cholesteric liquid crystalline phase which has a center wavelength of apparent selective reflection with respect to green light; and
a layer formed by immobilizing a cholesteric liquid crystalline phase which has a center wavelength of apparent selective reflection with respect to blue light.

11. The half mirror for displaying a projected image according to claim 7, further comprising:
a layer formed by immobilizing a cholesteric liquid crystalline phase which has a center wavelength of apparent selective reflection with respect to red light;
a layer formed by immobilizing a cholesteric liquid crystalline phase which has a center wavelength of apparent selective reflection with respect to green light; and
a layer formed by immobilizing a cholesteric liquid crystalline phase which has a center wavelength of apparent selective reflection with respect to blue light.

12. A combiner of a head up display, comprising the half mirror for displaying a projected image according to claim 1.

13. A combiner of a head up display, comprising the half mirror for displaying a projected image according to claim 10.

14. A combiner of a head up display, comprising the half mirror for displaying a projected image according to claim 11.

15. A projected image display system, comprising:
a projector; and
the half mirror for displaying a projected image according to claim 1,
wherein a light emission wavelength of a light source of the projector is in a selective reflection band of the layer formed by immobilizing the cholesteric liquid crystalline phase.

16. A projected image display system, comprising:
a projector; and
the half mirror for displaying a projected image according to claim 10,
wherein a light emission wavelength of a light source of the projector is in a selective reflection band of the layer formed by immobilizing the cholesteric liquid crystalline phase.

17. A projected image display system, comprising:
a projector; and
the half mirror for displaying a projected image according to claim 11,
wherein a light emission wavelength of a light source of the projector is in a selective reflection band of the layer formed by immobilizing the cholesteric liquid crystalline phase.

18. The projected image display system according to claim 15,
wherein the projector, the transparent medium, and the selective reflection layer are arranged in this order.

19. A head up display comprising:
a projector; and the combiner according to claim 12,
wherein a light emission wavelength of a light source of the projector is in a selective reflection band of the layer formed by immobilizing the cholesteric liquid crystalline phase.

20. A head up display comprising:
a projector; and the combiner according to claim 13,
wherein a light emission wavelength of a light source of the projector is in a selective reflection band of the layer formed by immobilizing the cholesteric liquid crystalline phase.
